(19) United States
(12) Patent Application Publication
(10) Pub. No.: US 2006/0273709 A1
(43) Pub. Date: Dec. 7, 2006

(54) Flat panel display having non-evaporable getter material

(75) Inventors: Liang Liu, Beijing (CN); Jie Tang, Beijing (CN); Bing-Chu Du, Beijing (CN); Cai-Lin Guo, Beijing (CN); Zhao-Fu Hu, Beijing (CN); Pi-Jin Chen, Beijing (CN); Shou-Shan Fan, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 11/432,241

(22) Filed: May 10, 2006

(30) Foreign Application Priority Data
Jun. 3, 2005 (CN) 200510035140.3

(51) Int. Cl. H01J 29/94

(52) U.S. Cl. 313/481

(57) ABSTRACT

A flat panel display (7) generally includes a front substrate (79) and a rear substrate (70) opposite thereto. The front substrate is formed with an anode (78). The rear substrate is formed with a cathode (71) facing the anode. Several sidewalls (72) are interposed between the front substrate and the rear substrate. At least one of the sidewalls has a getter unit (82), and a securing member (822) for fixing the getter unit thereon. The getter unit is comprised of non-evaporable getter material. Thereby maintaining a substantial vacuum in a chamber between the front substrate and the rear substrate.

### CROSS-REFERENCE TO RELATED APPLICATION

This application is related to a copending U.S. patent application Ser. No. ______ filed ______ (US6979) entitled “FLAT PANEL DISPLAY HAVING NON-EVAPORABLE GETTER MATERIAL” with the same assignee. The disclosure of the above-identified application is incorporated herein by reference.

### BACKGROUND

1. Field of the Invention

The present invention relates to a flat panel display, and particularly to a flat panel display having non-evaporable getter material.

2. Discussion of the Related Art

Flat panel displays are packaged vacuum microelectronic devices that are used in connection with computers, television sets, camcorder viewfinders, and other electronic devices. Flat panel displays generally have a rear plate and a front plate facing one another across a narrow vacuum gap. In large flat panel displays, a number of spacers are positioned between the rear plate and the front plate to prevent atmospheric pressure from collapsing the plates together. The rear plate typically has a base substrate upon which a number of sharp, cone-shaped emitters are formed, an insulator layer positioned on the substrate having apertures through which the emitters extend, and an extraction grid formed on the insulator layer around the apertures.

One problem with flat panel displays is that the internal components continuously outgas, which causes the performance of flat panel displays to degrade over time. The effects of outgassing are minimized by placing a special material to absorb the gas (commonly called getter material) within the sealed vacuum space. Accordingly, in order to absorb the gas in the vacuum chamber over a flat panel display's lifetime, a sufficient amount of getter material must be incorporated into the flat panel display before it is sealed.

The getter material generally includes two types: evaporable, and non-evaporable. The former is not suitable for use in flat panel displays because of the possible short-circuit caused by evaporating metal film. When non-evaporable getter materials are used, they are usually arranged in a corner of the flat panel device, but the conductance from the outgassing site to these getters are limited by the narrow space between the flat plates, causing reduction of the getters' absorption efficiency and in consequence the display's performance and lifetime. There are also according solutions in which a separate space for containing getter materials is added to the device, but the structure thereof becomes complicated and the manufacture cost will be increased.

What is needed, therefore is to provide a flat panel display having non-evaporable getter material that has a high absorption efficiency.

### SUMMARY

A flat panel display provided herein generally includes: a first substrate having an anode formed thereon, a second substrate having a cathode device formed thereon, and a plurality of sidewalls interposed therebetween. Therein, at least one of the sidewalls has a getter unit, and a securing member for fixing the getter unit thereon. The getter unit is comprised of non-evaporable getter material.

These and other features, aspects, and advantages of the present backlight device will become more apparent from the following detailed description and claims, and the accompanying drawings.

### BRIEF DESCRIPTION OF THE DRAWINGS

Many aspects of the present flat panel display can be better understood with reference to the following drawings. The components in the drawings are not necessary drawn to scale, the emphasis instead being placed upon clearly illustrating the principles of the present flat panel display. Moreover, in the drawings, like reference numerals designate corresponding parts throughout the several views.

FIG. 1 is a schematic, cross-sectional view of a flat panel display in accordance with a first embodiment;

FIG. 2 is a schematic, plan view of a sidewall of the flat panel display shown in FIG. 1, and

FIG. 3 is a schematic, cross-sectional view of another getter device in accordance with a second embodiment.

### DETAILED DESCRIPTION OF THE PREFERRED EMBODIMENTS

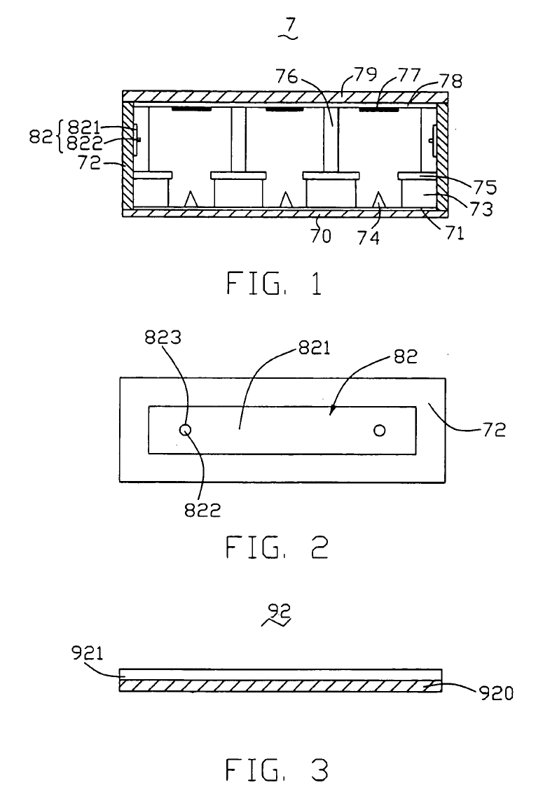

Referring to FIG. 1, a flat panel display 7 is shown in accordance with a first embodiment. The flat panel display 7 generally includes a front substrate 79 and a rear substrate 70 opposite thereto. The front substrate 79 is formed with an anode 78. The rear substrate 70 is formed with a cathode 71 facing the anode 78. Several sidewalls 72 are interposed between the front substrate 79 and the rear substrate 70. A plurality of getter devices 82 are arranged on the sidewalls 72. Thereby, a a substantial vacuum is maintained in the chamber between the front substrate 79 and the rear substrate 70.

In the illustrated embodiment, the rear substrate 70 is made of glass. The cathode 71 is an electrically conductive layer, and formed on a surface of the rear substrate 70 facing the anode 78. A plurality of emitters 74 are formed on the cathode 71, for emitting electrons. The emitters 74 can be composed of carbon nanotubes, diamond, diamond-like carbon (DLC), silicon, or of a tip-shaped metal material. The cathode 71 is also formed with an insulating layer 73. The insulating layer 73 includes a plurality of tiny through holes corresponding to the emitters 74, for exposing the emitters 74. A plurality of grid electrodes 75 are formed on a top surface of the insulating layer 73, for extracting electrons from the emitters 74.

Referring to FIGS. 1 and 2, the front substrate 79 has a cathode-facing surface 792. The surface 792 includes a middle region 794 and edge regions 796 surrounding the middle region 794 and adjacent to the sidewalls 72. The anode 78 is a conductive layer formed on the middle region 794, and is generally made of indium-tin oxide. Fluorescent layers 77 are formed on an emitter-facing surface of the anode 78. Considering the distribution of the emitters 74 and the cost, the anode 78 and the fluorescent layers 77 are not arranged on the edge regions 796 of the surface 792.

Referring to FIGS. 1 and 2, the getter devices 82 are respectively arranged on surfaces of the sidewalls 72 facing the chamber, for uniformly absorbing the gas in the chamber of the flat panel display 7. Each of the getter devices 82 includes a main body 821 having two through holes 823 defined therein and two securing posts 822. Each of the securing posts 822 has one end fixed on one of the sidewalls 72, and has an opposite end extending from the corresponding through hole, for securing the whole getter device 82 on the one of the sidewall 72. The getter devices 82 have structures easy to manufacture, and have reasonable absorption arrangements to improve the absorption efficiency. Therefore, the flat panel display 7 will have a longer life.

In the illustrated embodiment, the main body 821 is a strip shaped sheet comprised of the non-evaporable getter material. An absorption area of the main body 821 is thereby increased. Alternatively, if desired, the getter devices 82 may be in other shapes, such as wires. The non-evaporable getter material is selected from titanium, zirconium, molybdenum, thorium, hafnium, an alloy comprised of at least two of the above metals, and any other suitable metal material.

Furthermore, the securing posts 822 are generally made of metal. The securing posts 822 may have other shapes, or can be replaced with other suitable securing components, for example, metal clips, metal wires. The number of the securing posts may be changed if desired. The numbers and sizes of the through holes 823 may be changed according to those of the securing posts 822.

Referring to FIG. 3, another getter device 92 is shown according to a second embodiment as a replacement of the getter device 82. The getter device 92 includes a base 920 and a getter layer 921 formed thereon. The getter layer 921 is strip-shaped, and is comprised of non-evaporable getter materials. The getter layer 921 may be deposited on the base 920 by electroplating, screen printing, settling out of solution, electrophoresis processing, or other suitable deposition processes. Similar to the getter device 82, the getter device 92 may also have some through holes defined therein, and be fixed on one of the sidewalls 72 by the securing posts 822 or other suitable securing components.

It should be further noted that the above-described flat panel display 7 has been provided for the purposes of illustrating the present invention. The flat panel display 7 is not critical to practicing the present invention. A variety of conventional flat panel displays are known to those skilled in the art, and these may be suitably adapted for practicing the present invention. In particular, the amounts of the getter devices 82, 92 are exemplified herein for illustration purposes only, and are not intended to limit the present invention.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A flat panel display comprising:
a first substrate having an anode formed thereon, a second substrate having a cathode device formed thereon; and
a plurality of sidewalls interposed between the first substrate and the second substrate, at least one of the sidewalls having a getter unit and a securing member for fixing the getter unit thereon, the getter unit comprised of non-evaporable getter material.

2. The flat panel display according to claim 1, wherein the getter unit includes a through hole defined therein, the securing member extending from the through hole.

3. The flat panel display according to claim 1, wherein the getter unit includes a strip shaped sheet comprised of the non-evaporable getter material.

4. The flat panel display according to claim 1, wherein the getter unit includes a base for supporting the non-evaporable getter material.

5. The flat panel display according to claim 1, wherein the securing member is a metal post.

6. The flat panel display according to claim 1, wherein the securing member is a metal wire.

7. The flat panel display according to claim 1, wherein the securing member is a metal clip.

8. The flat panel display according to claim 1, wherein the cathode device is a field emission cathode including an electrically conductive layer and a plurality of emitters formed on the electrically conductive layer.

9. The flat panel display according to claim 8, wherein a material of the emitters is selected from the group consisting of carbon nanotubes, diamond, diamond-like carbon (DLC), silicon, and a tip-shaped metal material.
